(19) United States
(12) Patent Application Publication
(10) Pub. No.: US 2004/0244649 A1
(43) Pub. Date: Dec. 9, 2004

(54) Metal colloid luster color material and method of producing thereof

(76) Inventors: Kazuhiro Kato, Toyota-shi (JP); Ayako Iwakoshi, Toyonaka-shi (JP); Toshikatsu Kobayashi, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/827,519

(22) Filed: Apr. 20, 2004

(30) Foreign Application Priority Data
Apr. 21, 2003 (JP) 2003-116135

(51) Int. Cl. C09C 1/62

(52) U.S. Cl. 106/403; 106/499; 106/415; 428/403

(57) ABSTRACT

A metal colloid luster color material having an unique appearance without using any organic color material that is deficient in weather resistance as the coloring component is obtained.

The present invention is a metal colloid luster color material, in which a surface of a core material being a metal flake or an inorganic flake etc. is covered with a metal species of a metal colloid particle selected from the group consisting of gold, silver, and copper. This metal colloid luster color material is obtained by causing a metal colloid particle in solution to undergo adhesion to a surface of a core material.

### TECHNICAL FIELD

The present invention relates generally to a metal colloid luster color material.

### BACKGROUND ART

Metallic coatings containing aluminum flakes as luster color materials give good appearance films, so this method is the mainstream coating method of automotive body today. To impart a better appearance with such the metallic coatings, colored aluminum flakes prepared by depositing a color pigment on aluminum flakes are sometimes used. However, when an organic material which is deficient in weather resistance is used as said color pigment, the weather resistance of the coating film containing such colored aluminum flakes is unsatisfactory [cf. Japanese Kokai Publication Hei-09-40885 (claim 1)].

As a means for overcoming the above drawback, a method has been disclosed which comprises covering the aluminum surface with various metals by sputtering. In this method, however, the metal species to be sputtered are limited and, moreover, the metal is covered the surface so uniformly that an appearance of film which contains the covered aluminum is not unique [cf. Japanese Kokai Publication Hei-04-354882 (col. 5, l.43˜col. 6, l.27, page 2)].

On the other hand, it is a known method to reduce noble metal ions on aluminum surfaces. However, the covering by the metal is quite uniform just as it is true of the above sputtered one so that an appearance of film is not unique, too. Moreover, this procedure is intended to provide a core for electroless plating and there is no teaching about the use of the product as a luster color material [cf. Japanese Kokai Publication 2003-49091 (claim 1)].

### SUMMARY OF THE INVENTION

The present invention has for its object to provide a metal colloid luster color material which gives an unique appearance for coating without using any organic color material that is deficient in weather resistance as the coloring component.

The metal colloid luster color material of the present invention comprises a core material and a metal colloid particle. In this metal colloid luster color material, the metal colloid particle may be adherent to a surface of the core material, and the metal species of said metal colloid particle may be at least one member selected from the group consisting of gold, silver, and copper. Furthermore, said core material may comprise a metal flake or an inorganic flake. The metal colloid luster color material of the present invention may further contain an organic component.

The method of producing the metal colloid luster color material according to the present invention comprises a step of causing a metal colloid particle in solution to undergo adhesion to a surface of a core material. In this method, an organic component may be used for said adhesion. Moreover, said organic component may be or may be not a component derived from the metal colloid particle or the core material. Moreover, in the case where said organic component is one derived from the metal colloid particle or the core material, it may additionally contain an organic component that is not derived from the metal colloid particle or the core material. In addition, said adhesion may be performed by addition of a poor solvent for said organic component.

The metal colloid luster color material of the present invention is a product obtained by the above method of producing.

The coating composition of the present invention contains said metal colloid luster color material.

The coating film of the present invention is one resulting from said coating composition.

### DETAILED DESCRIPTION OF THE INVENTION

The metal colloid luster color material of the present invention comprises a core material and a metal colloid particle, and the metal colloid luster color material is preferably one resulting from adhesion of the metal colloid particle to the surface of said core material. The core material mentioned above preferably is the metal flake, such as an aluminum, a zinc, a copper, a bronze, a nickel, a titanium, or a stainless steel flake, or the inorganic flake, such as a mica or a glass flake. In consideration of the appearance of a coating film and ease of handling, the aluminum flake is particularly preferred. When the core material has a flaky form, the preferred core material has a thickness of 0.1-5 μm and an average size of 5 to 100 μm, with a shape coefficient, namely the product of average size divided by thickness, being within the range of about 5 to 100. Optionally, said core material has a grainy form. The kind of core material in this case includes ceramics, such as alumina, in addition to the kind of said metallic and inorganic flake. In the case of said particle form, the core material having a particle diameter of about 5 to 1000 μm, preferably 10 to 100 μm, can be used.

On the other hand, the metal colloid particle, which is the other component of the metal colloid luster color material of the present invention, is the metal particle having an average particle diameter of 1 to 100 nm. This metal colloid particle can be obtained by various methods known to those skilled in the art, such as the evaporation-in-gas method described in Japanese Kokai Publication Hei-03-34211 and the reductive precipitation method described in Japanese Kokai Publication Hei-11-319538, to mention but a few examples. The metal species of said metal colloid particle is preferably at least one member selected from the group consisting of gold, silver, and copper. This is because, when reduced in size to fine particle diameter, these metals show unique colors due to plasmon absorption. The uniqueness of appearance can be further enhanced by using a composite particle of two of these preferred metal species, for example gold and silver.

The metal colloid luster color material according to the present invention may further contain an organic component in addition to the inorganic components, namely said metal colloid particle and core material. As this organic component, a stabilizer for maintaining the form of metal colloid particle and a protectant for preventing corrosion of the core material can be mentioned by way of example. The term “maintaining the form” means prevention of aggregation of the particle and oxidation of the metal. As examples of said stabilizer, there can be mentioned protective colloids such as polymer compounds and polycarboxylic acids, and oxidation inhibitors such as amines, among others. An amount and kind of such stabilizers vary according to the metal species, particle diameter, and producing method of the metal colloid particle. For example, the metal colloid particle obtained by said reductive precipitation method contains the protective colloid, which is pigment dispersing polymer as a stabilizer. As said protectant, assuming that the core material is an aluminum flake, an oleic acid, a stearic acid, etc. may be mentioned as examples. Moreover, said organic component includes a resin for adhering the metal colloid particle to the core material, a pigment dispersing agent, a silane coupling agent, a chelating compound, and so forth.

The ratio of the metal colloid particle to the core material in the metal colloid luster color material of the present invention is preferably 1/20 to 10/1 on a weight basis. If the ratio is less than 1/20, expression of the uniqueness of appearance due to the metal colloid particle can hardly be expected. Exceeding 10/1 is not efficient, for it will not be rewarded with a commensurate effect. In the metal colloid luster color material of the present invention, a surface of the core material need not be completely covered by the metal colloid particle.

The above-mentioned organic component in the metal colloid luster color material of the present invention is low in specific gravity as compared with the inorganic components, namely the metal colloid particle and core material. Its proportion is usually 1 to 85 weight % based on the metal colloid luster color material.

A method of producing a metal colloid luster color material according to the invention comprises a step of causing a metal colloid particle in solution to undergo adhesion to a surface of a core material. Thus, using a metal colloidal solution, the metal colloid particle is caused to adhere to the core material. The term “metal colloidal solution” means a uniform dispersion of a metal colloid particle in a solvent, which can be handled as a solution.

The above-mentioned adhesion in the method of producing a metal colloid luster color material according to the present invention can be performed by the well-known techniques. Since the metal colloid particle have very small particle diameter, that can be caused to adhere to said core material by intermolecular attraction. Moreover, depending on the kind of core material, the above adhesion may take place as the core material and the metal colloid are electrically positive or negative charged, oppositely. For said adhesion, the system may be added with an organic component such as a resin, a pigment dispersing agent, a silane coupling agent, and/or a chelating compound. These are generally added to a dispersion of the core material or said metal colloid solution. It is also possible that the stabilizer or protectant which is contained in said metal colloid particle or said core material itself is utilized for said adhesion. Thus, the organic component to be used for said adhesion may be one derived from the metal colloid particle or the core material or one not derived therefrom. In cases where the organic component to be used for said adhesion is one derived from the metal colloid particle or core material, an additional organic component not derived from the metal colloid particle or core material may be supplementally added.

In the method of producing a metal colloid luster color material according to the present invention, said adhesion may be performed by adding a poor solvent for said organic component. For example, in the case where the core material is stearic acid-protected aluminum flake, the metal colloid is one obtained by said reductive precipitation method, and its protective colloid is a pigment dispersing polymer having a high affinity for nonpolar organic solvents, the metal colloid particle can be deposited on the surface of the aluminum flake by adding a water-soluble organic solvent such as methanol or ethanol to these components in a water-insoluble organic solvent such as toluene, thus giving the desired metal colloid luster color material. Here, toluene referred to above is a good solvent for said protectant and pigment dispersing polymer, while methanol and ethanol referred to above are poor solvents.

The progress of adhesion during the procedure can be visually monitored. Moreover, the adhesive state of metal colloid particle onto the surface of the core material can be confirmed by observing the resulting metal colloid luster color material with a transmission electron microscope. The metal colloid luster color material thus obtained may be coated with a polymer material by a technique well known to any one skilled in the art for further stabilization of the adhesion of the metal colloid particle.

The coating composition of the present invention contains the metal colloid luster color material described above. Generally a coating composition comprises of a binder component and a color component. The binder component in the coating composition of the present invention may be a lacquer type one which does not utilize a curing reaction but usually comprises of a curable functional group-containing resin and a curing agent. As the above curable functional group-containing resin, there can be mentioned polyester resins, acrylic resins, alkyd resins, epoxy resins, urethane resins, etc. which are commonly used as resins for coating applications. The curable functional groups in such resins are not particularly restricted but include carboxyl, hydroxyl, epoxy, isocyanate, and other groups. As to said curing agent, the appropriate curing agent can be selected from among the agents well known to one skilled in the art according to the kind of said curable functional group.

On the other hand, in the coating composition of the present invention, the metal colloid luster color material described above is contained as said color component. The proportion, by weight, of said metal colloid luster color material based on 100 weight parts solids of the coating composition may for example be 0.01 to 30%, preferably 1 to 20%. The total color component content is preferably less than 50%, more preferably less than 30%. If it exceeds 50%, the coating film tends to be degraded in appearance.

As the pigment component other than said metal colloid luster color material, a color pigment and/or a filler pigment is commonly used. The color pigment mentioned just above includes inorganic color pigments, such as titanium dioxide, carbon black, graphite, yellow lead, yellow iron oxide, red iron oxide, etc., and organic color pigments such as azo-chelate pigments, insoluble azo pigments, condensed azo pigments, phthalocyanine pigments, indigo pigments, perinone pigments, perylene pigments, dioxane pigments, quinacridone pigments, isoindolinone pigments, metal complex pigments, and so forth. As the filler pigment, calcium carbonate, barium sulfate, kaolin, aluminum silicate (clay), talc, etc. can be mentioned. Moreover, luster color pigments other than said metal colloid luster color material can be additionally used. As such luster color pigments, there can be mentioned aluminum powder, mica powder, glass powder, bronze powder, titanium powder, and so forth. As the luster color pigment, the above-described metal colloid particle itself can also be used. In this case, the very metal colloid particle may or may not be the same as that used in the metal colloid luster color material.

Furthermore, where necessary, the coating composition may contain various additives well known to those skilled in the art in addition to the components described hereinbefore, such additives including a pigment dispersing agent, a surface conditioner, a rheology controller, an ultraviolet absorber, an antioxidant, and so forth. Generally the coating composition of the present invention is preferably provided in a solution form, and may assume the form of an organic solvent-borne coating, a water-borne coating (an aqueous solution, dispersion or emulsion) or a non-aqueous dispersion coating.

As the metal colloid luster color material is contained in the coating composition of the present invention, an attractive coating film with an unique appearance can be obtained. Therefore, the coating composition of the present invention is used preferably as a base coating for automotive body coating. In the coating of automotive bodies, while it is common practice to form a base coating film with base coating composition for visual effect and further form a clear coating film for protection of the base coating film and an added different visual effect, the two coatings are usually formed wet-on-wet. In this case, said base coating is preferably provided in the form of a water-borne coating from the standpoint of environmental protection. The clear coating for forming said clear coating film, which is well known to those skilled in the art can be employed.

A coating film of the present invention is one resulting from said coating composition and since it contains the metal colloid luster color material, the coating film has an unique appearance. When said coating composition is applied as a base coating for automotive bodies, an intermediate coating film is usually constructed under the resulting coating film in advance and a clear coating film is generally formed on top of the coating film of the present invention.

Because the metal colloid particle is used as its color component in the metal colloid luster color material of the present invention, it is expected to be more resistant to weathering than the one using an organic color material. Moreover, in cases where the metal colloid particle is a species which shows a special color due to plasmon absorption, the coating film having an unique appearance is obtained by using the metal colloid luster color material of the present invention. This effect is particularly prominent when the core material is a metal flake such as an aluminum flake. This may be because the color development of metal colloid particle is caused not only by the reflection of external light but also by the transmission of reflection light from the core material through the metal colloid particle simultaneously. To the eye, it is guessed that these two kinds of colors are compounded to give an unique appearance.

### DETAILED DESCRIPTION OF THE INVENTION

### EXAMPLES

### Production Example

Preparation of a Gold Colloidal Solution

A solution of 42.00 g of chloroauric acid in 139.70 g of deionized water was added to a solution of 26.76 g of Solsperse 32550 (nonvolative matter 50%; product of Avecia Co.), which is a pigment dispersing polymer having a high affinity for nonpolar organic solvents, in 210.94 g of acetone, followed by stirring. 45.38 g of dimethylethanolamine was added to the resulting mixture, whereupon a deep purple-colored oil apparently composed of gold colloid particles separated out. The supernatant was then decanted off. 350 g of deionized water was added to the residual oil, the mixture was stirred and, then, allowed to stand. After separation of the supernatant from the deep purple-colored oil, the supernatant was removed again by decanting. This washing procedure was repeated until the conductivity of the supernatant had become 6 μS/cm or less.

Then, 350 g of methanol was added to the residual deep-purple oil and the mixture was stirred and, then, allowed to stand. Thereafter, the supernatant methanol was removed. This procedure was repeated for a total of 2 times and the methanol was further removed by air-drying at room temperature. Then, 350 g of toluene was added for dissolving the deep-purple oil and the resulting solution was allowed to stand at room temperature. After the volume of the solution had decreased, toluene was further added. This procedure was repeated twice to remove the residual methanol and water to finally obtain 90.90 g of a toluenic gold colloidal solution with a solids content of 30 weight %.

### Example 1

Production of a Gold Colloid Luster Color Material

28 parts of the aluminum paste MH-8801 (product of Asahi Chemical Industry Co.; solids content: 65 weight %) was added to 300 parts of toluene, followed by addition of 82 parts of the toluenic gold colloidal solution (solids content: 30weight %) obtained in the above Production Example, followed by mixing. 3 volumes of ethanol per volume of toluene was added to this mixture therein, whereupon bluish pink-colored aluminum flakes separated out. Observation of the aluminum flakes with a transmission electron microscope revealed that the gold colloid had adhered to the surface of aluminum flake partly.

### Example 2

Production of a Coating Composition and a Coating Film

A coating composition was produced by adding the gold colloid luster color material obtained in Example 1 to the binder component available upon omission of the pigment component from the acrylic melamine-curable base coating Superlac M-350 manufactured by Nippon Paint Co. at a formulating level corresponding to 10 weight % based on the nonvolatile matter of the coating composition. This coating composition was sprayed onto a test panel having a gray intermediate coating (surfacer) in a dry film thickness of 15 μm and Macflow-O-1810 (an acid epoxy-curing clear coating, product of Nippon Paint Co.) was similarly sprayed in a dry film thickness of 30 μm followed by baking to provide a coating film. The coating film was confirmed to gain in intensity of the reddish color when exposed to light, thus exhibiting an unique appearance which had never been available.

1. A metal colloid luster color material comprising a core material and a metal colloid particle.

2. The metal colloid luster color material according to claim 1,
wherein said metal colloid particle is adherent to the surface of said core material.

3. The metal colloid luster color material according to claim 1 or 2,
wherein the metal species of said metal colloid particle is at least one member selected from the group consisting of gold, silver, and copper.

4. The metal colloid luster color material according to claim 1 or 2,
wherein said core material is a metal flake or an inorganic flake.

5. The metal colloid luster color material according to claim 1 or 2,
which further comprises an organic component.

6. A method of producing a metal colloid luster color material,
which comprising a step of causing a metal colloid particle in solution to undergo adhesion to a surface of a core material.

7. The method of producing a metal colloid luster color material according to claim 6,
wherein an organic component is used for said adhesion.

8. The method of producing a metal colloid luster color material according to claim 7,
wherein said organic component is derived from the metal colloid particle or the core material.

9. The method of producing a metal colloid luster color material according to claim 8,
wherein said organic component further contains one not derived from the metal colloid particle or the core material.

10. The method of producing a metal colloid luster color material according to claim 8,
wherein said organic component is one not derived from the metal colloid particle or the core material.

11. The method of producing a metal colloid luster color material according to any of claims 6 to 10,
wherein said adhesion is performed by addition of a poor solvent for said organic component.

12. A metal colloid luster color material as obtained by the method of producing a metal colloid luster color material according to claim 6.

13. A coating composition containing the metal colloid luster color material according to claim 1 or 12.

14. A coating film resulting from the coating composition according to claim 13.
